(19) United States
(12) Patent Application Publication
(10) Pub. No.: US 2011/0288743 A1
(43) Pub. Date: Nov. 24, 2011

(54) SYSTEM, APPARATUS AND METHOD FOR VEHICLE IDLING REDUCTION

(76) Inventor: Roger Neil Smith, Toronto (CA)

(21) Appl. No.: 13/110,459

(22) Filed: May 18, 2011

Related U.S. Application Data
(60) Provisional application No. 61/345,814, filed on May 18, 2010.

(51) Int. Cl. F02D 41/16

(52) U.S. Cl. 701/102

(57) ABSTRACT

The present invention is a system, apparatus and method for an overall power management system for powering one or more power consuming devices used in vehicles and assisting with the management of auxiliary energy storage, while ensuring that the starter battery remains charged for engine starting. The present invention may be an integrated system, and related apparatus, for managing a plurality on-board power consuming devices and power sources. The present invention may be utilized to reduce the need for engine idling to maintain power to one or more power consuming devices. The present invention may include: a monitoring device to monitor the power consumption of one or more power consuming devices and/or the charge of one or more auxiliary energy storage devices and an a starter battery; and a control device to ensure that the power consuming devices are powered while a vehicle is in a stationary position.

This application claims the benefit of U.S. Provisional Patent Application Ser. No. 61/345,814 filed May 18, 2010.

### FIELD OF INVENTION

The present invention relates generally to power management systems and devices for use in vehicles.

### BACKGROUND OF THE INVENTION

Many vehicles have on-board systems which have power sources that require that the engine of a vehicle be run. The power requirements of such prior art on-board systems generally cannot be met by using batteries or other power sources that do not require that the vehicle engine be run. This results in the requirement that vehicles be idled to maintain the power sources. The act of idling in turn results in significant fuel consumption and emissions. Additionally, significant idling over time can have a negative impact on a vehicle's engine. It may be the cause of additional maintenance, or may reduce the life of an engine.

In prior art systems the alternator generates electricity when the vehicle engine is started. While the engine is running, it recharges the starting battery and also powers all of the vehicle's electrical loads. Such electrical loads can include cooling systems, heating systems, headlights, running lights, the dash fan, turn signals and flashers, radio and accessories. The Original Equipment Manufacturer (“OEM”) sizes the battery requirements based on normal power requirements. However, there are numerous vehicles where additional onboard power consuming devices are required.

For example, police vehicles and emergency response vehicles have additional onboard power consuming devices. Police vehicles require network-connected computer devices to access for example motor vehicle data and criminal watch lists, and radio equipment. Ambulances also include medical diagnostic and emergency response equipment. Other vehicles can require inverters to recharge cordless power tool batteries or laptops.

Maintaining environment controls (such as heat and cooling) in vehicles where drivers or passengers spend significant period of time in the vehicle in a parked position creates a significant power demand. Depending on the application, additional power consuming devices may include hydraulic pumps, and air compressors. Many other power consuming devices are possible, and all of these are collectively referred to as “power consuming devices” in this disclosure.

These additional power requirements exceed battery power requirements of OEM vehicles. Accordingly in practice, operators idle the vehicle engine to avoid dead starting batteries and also to maintain a comfortable temperature in the cab or work area or patient area. Alternatively, power consuming devices that would be advantageous to use in the field are not installed into vehicles, or their use is limited, to avoid either the need to idle the engine, or risk draining the vehicle battery.

Vehicle idling consumes fuel and impacts the environment with unnecessary greenhouse gases and particulate matter emissions. Given the high percentage of engine idle time versus run time, this is an issue. As the cost of fuel escalates, the pressure to lower fuel consumption will increase. Engine run time from idling increases engine wear and tear, and leads to higher maintenance cost and shorter vehicle life.

Some prior art systems are operable to restart a vehicle engine before power consuming devices drain the starting battery. As an example, U.S. Pat. No. 7,091,629 discloses a control system and method for automatically starting and stopping a combustion engine to maintain starting battery voltage and maintain vehicle interior temperature. As another example, U.S. Pat. No. 6,895,917 discloses an automatic stop/start controller for a vehicle engine to power an A/C compressor for vehicle interior cooling.

### SUMMARY OF THE INVENTION

In one aspect, the present disclosure relates to a system requiring limited idling by a vehicle in a stationary position, said system comprising: at least one monitoring device linked to one or more power consuming devices of the vehicle and to one or more power sources, said at least one monitoring device being operable to monitor the one or more power consuming devices and the one or more power sources; and at least one control device linked to the monitoring device, said control device being connected to electrical circuitry of the vehicle, and said control device being operable to start and shut off an engine of the vehicle as required to supply power to the one or more power consuming devices from the one or more power sources, in accordance with the monitoring by the at least one monitoring device.

In another aspect, the present disclosure relates to a method for powering one or more power consuming devices of a vehicle while the vehicle is stationary, the method comprising the steps of: at least one monitoring device monitoring one or more power sources of the vehicle; and a control device stopping and starting the engine of the vehicle in accordance with the monitoring of the at least one monitoring device to supply power to the one or more power consuming devices from the one or more power sources.

In yet another aspect, the present disclosure relates to a computer program product operable for powering one or more power consuming devices while a vehicle is stationary with reduced idling of the vehicle, said computer program product comprising: one or more instructions processable by one or more computer processors to communicate the one or more instructions to a control device linked to the computer program product, said one or more instructions including one or more thresholds relating to one or more of the following: the one or more power consuming devices; and one or more power sources of the vehicle; and the control device starting and shutting of the vehicle in accordance with the one or more instructions and the one or more thresholds to cause the one or more power sources to supply power to the one or more power consuming devices.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 is a system diagram of the system components of an embodiment of the present invention.

FIG. 2 is a flow diagram illustrating the main aspects of a method of an embodiment of the present invention.

FIG. 3 shows an installed auxiliary energy storage device in the trunk of a vehicle.

FIG. 4 is a system diagram of the integration of the various components of the system of an embodiment of the present invention.

FIG. 5 is a system diagram of an electrical circuitry of an embodiment of the present invention.

FIG. 6 is a table showing electrical loads that may be required by devices utilized in vehicles and therefore may be serviced by an embodiment of the present invention.

FIG. 7 is a system diagram of an electrical circuitry of an embodiment of the present invention integrated with an existing OEM system.

FIG. 8 is a system diagram of an electrical circuitry of an embodiment of the present invention integrated with hybrid engine technologies

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION OF THE PREFERRED EMBODIMENT

The present invention is a system, apparatus and method for an overall power management system for powering one or more power consuming devices used in vehicles and assisting with the management of auxiliary energy storage, while ensuring that the starter battery remains charged for engine starting. The present invention may be an integrated system, and related apparatus, for managing a plurality on-board power consuming devices and power sources. The present invention may be utilized to reduce the need for engine idling to maintain power to one or more power consuming devices. The present invention may be a system that integrates, or is integrated with, one or more of the following: (i) a plurality of power consuming devices or sub-system power consuming devices; and (ii) one or more auxiliary energy storage devices. The present invention may include a monitoring device or sub-system operable to monitor the power consumption of one or more power consuming devices and/or the charge of one or more auxiliary energy storage devices and an OEM battery. The present invention may include a control device or system operable to ensure that the power consuming devices are powered while a vehicle is in a stationary position.

The present invention may be operable to reduce the amount of vehicle idling that is required to power devices and components of the vehicle while a vehicle is stationary. A monitoring device or system may be linked to one or more power consuming devices or sub-systems of a vehicle. A control device may be linked to the monitoring device and electronically integrated with the vehicle. The control device may be operable to initiate power consuming devices to be powered using one or more auxiliary energy storage devices of the vehicle, when the vehicle is in a stationary position. The control device may further be operable to switch the vehicle engine on when the auxiliary energy storage devices have been drained to a first predetermined threshold in order to recharge the auxiliary energy storage devices, and when these have been recharged to a second predetermined threshold, switch the vehicle engine off. The system may be integrated with existing engine systems, including hybrid engine systems.

The term “vehicle” is utilized herein to generally reference any type of motorized vehicle, including boats, automobiles, buses, all terrain vehicles, planes, scooters, recreation vehicles, motorcycles, trucks, and any other motorized vehicle. The term “the vehicle is in park” is utilized herein to indicate that a vehicle is stationary and that a user may be utilizing components of the vehicle or power consuming devices connected to the vehicle while the vehicle is stationary. The term “the vehicle is in park” therefore references when a vehicle is in a park setting, a neutral setting, or any other setting whereby the vehicle is stationary and power is required to power components of the vehicle or power consuming devices connected to a vehicle. The term “power consuming device” may reference power consuming devices that are components of the vehicle, for example, such as headlights, a radio, etc., or power consuming devices that are removeably connected to the vehicle, for example, such as a laptop, an aftermarket DVD player, an aftermarket GPS, a cellphone charger, etc. Power consuming devices generally may include: a heating unit; an air conditioning unit; emergency lighting; a radio; one or more power outlets operable to supply power to one or more power consuming devices connected to the vehicle; a cell phone charger; a laptop; a GPS; a computer; headlights, including fog lights or daytime running lights; an iPod, MP3 player or other music player; DVD player or other video player; a blower fan; turn signals; flashers; or any other power consuming device that may be integrated into, or connected to, a vehicle for use by a user of the vehicle.

The present invention may utilize one or more auxiliary power devices to power the power consuming devices when the vehicle is in a stationary position. The control device of the present invention may be operable to switch the engine off when certain conditions have been met. For example, the conditions may include that the idle time has exceeded predefined thresholds while the vehicle transmission has been in the park position. The control device may be operable to switch the engine on when the auxiliary energy storage devices have reached a determined power level. For example, the determined power level may be a level at which the power consuming devices will soon have insufficient power to meet their power requirements.

Embodiments of the present invention may include additional sensors or monitoring devices. For example, one embodiment of the present invention may accomplish monitoring by linking one or more temperature sensors to the system of the present invention. The temperature sensors may provide the sensor data to establish whether heating or air conditioning sub-systems need to be activated, as further described below. As another example, one embodiment of the present invention may monitor one or more auxiliary energy storage devices by receiving voltage information on an ongoing basis from the energy storage devices and OEM battery.

The present invention may be operable to organize the power consuming devices and auxiliary energy storage devices into a network. Power management of the power consuming devices in the network may be undertaken by the present invention. In the network the power consuming devices may be recognized as being linked or having other relationships.

Requirements for particular power consuming sub-systems may depend on the particular vehicle and its use. The control system of the present invention may be designed to provide power management functions described herein in connection with a wide assortment of power consuming devices. The control system of the present invention may also be designed to integrate with the vehicle systems, regardless of the specific auxiliary power sources or power consuming devices used in the vehicle and therefore required to be integrated with the present invention.

The control system may be operable to monitor the operating conditions of the vehicle. The control system may further optimize the use of the power consuming devices as well as which of the one or more associated auxiliary power devices are made available to supply power to the one or more power consuming devices. The control system may undertake to achieve such optimization on an ongoing basis. The control system may undertake the optimization based on electrical demand and/or environmental impact profiles relating to the power consuming devices and/or the associated auxiliary power devices. The electrical demand and/or environmental impact profile information may be stored to a memory of the present invention.

The system may offer particular benefits and advantages over the prior art. Power devices and power sources of prior art vehicles may require that the vehicle be idled in order to function. This idling required by the prior art may consume a significant amount of fuel. The present invention may reduce fuel consumption by requiring less idling of the engine of a vehicle. Therefore less fuel may be consumed by a vehicle, and fewer emissions may be released into the atmosphere when the present invention is utilized. The present invention may have a reduced environmental impact that the prior art.

As another benefit or advantage over the prior art, the present invention may reduce the wear and tear on the vehicle. Prior art systems that require idling of vehicles can result in the need for additional vehicle maintenance and can reduce engine life. The present invention does not require that a vehicle be idled constantly, and therefore the effect of such idling upon a vehicle will not occur. As a result, vehicle maintenance required for prior art systems may be avoided if the present invention is utilized. Additionally, the engine life may be extended by the present invention over the prior art.

As yet another benefit or advantage over the prior art, the present invention may also monitor the power available in the vehicle starter battery. Prior art systems that require constant idling of an engine may drain the starter battery. The present invention may monitor the starter battery to ensure that sufficient power is available to start the vehicle. The result is that the present invention avoids draining of the starter battery.

As still another benefit or advantage over the prior art, the present invention may make it easier to include additional power consuming devices that can provide benefit to the vehicle's users or the members of the public benefiting from use of the vehicles. Prior art systems that require that a vehicle be idled to provide power to power consuming devices may be limited regarding the number of power consuming devices that may be utilized in a vehicle. The present invention may provide for the use of additional power consuming devices, and these devices may offer certain functions and uses to a person in the vehicle that are particularly helpful or beneficial.

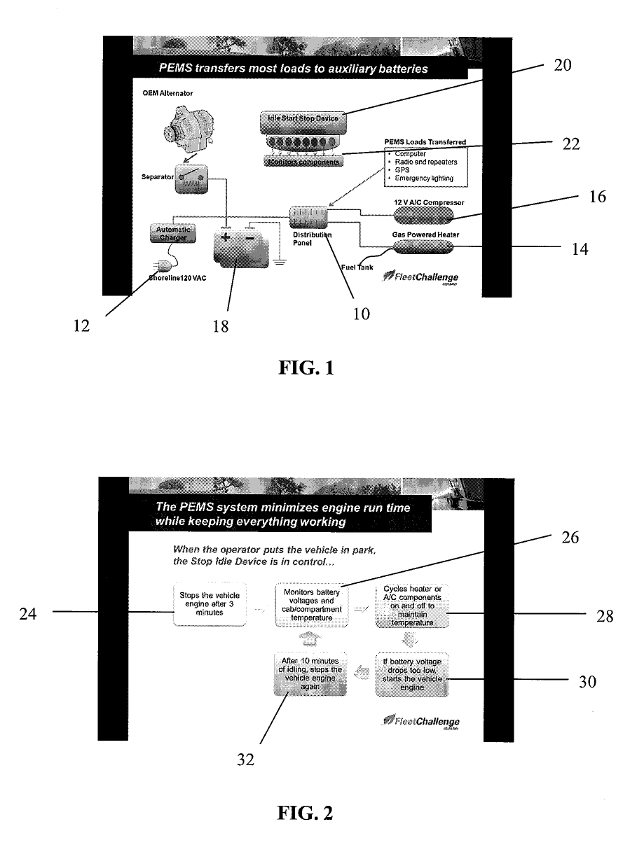

As shown in FIG. 1, the present invention may include several elements. The present invention may be utilized in a vehicle that requires the operation of numerous power consuming devices, for example, such as devices linked to a distribution panel 10. The devices linked to a distribution panel may include elements such as a computer, a radio and repeaters, a global positioning system (GPS), and emergency lighting. The vehicle may also offer one or more outlets 12 where one or more additional power consuming devices may be connected, as well as additional power consuming devices such as a heater 14, or a compressor 16. The vehicle may include a battery 18. The present invention may include an idle start stop device 20 that is connected to a variety of monitoring components 22 or sensors.

The monitoring components of the present invention may be linked to the power sources of the vehicle, for example, such as the battery, and any auxiliary power sources that are integrated with the vehicle or are provided by the present invention. The monitoring components or other sensors of the present invention may monitor the power levels of the battery of the vehicle and any auxiliary power sources provided in the vehicle or by the present invention. The idle start stop device may be operable to start the engine of the vehicle so as to start the vehicle idling should the one or more monitors or sensors indicate that the vehicle is required to be idled to maintain power to one or more of the power consuming devices. The idle start stop device may also be operable to turn the engine off and thereby cease idling when it is not necessary to idle the vehicle in order to provide power to the power consuming devices.

In one embodiment of the present invention, as shown in FIG. 2, when the vehicle is put into park a stop idle device may stop the vehicle engine at a specific period of time after the vehicle is put into park 24. For example, the period of time may be 3 minutes after the vehicle is put into park, or at any other period of time. The monitoring components, or other sensors, may monitor the battery power level, such as the voltages of the battery 26. A temperature sensor may be utilized to sense the temperature of any interior area of the vehicle if particular temperature settings have been chosen by a user, such as a specific level of heat, or a specific level of cool that should be maintained within the interior area. The present invention may operate a heater or an air conditioner unit of the vehicle, for example, such as operating to turn the heater and/or air conditioner unit one and off as necessary to maintain the specific level of heat or cool within the interior area 28. The monitoring components may monitor the battery on an ongoing basis and may determine if the battery voltage drops to a set level 30.

If the battery voltage drops to the set level then the present invention may operate the engine of the vehicle to start the engine so that the vehicle is idling. The set level may be a level that indicates that the battery is getting close to being drained and requires idling to remain charged sufficiently to be able to start the engine. The present invention may stop the engine after a set period of time 32, for example, such as 10 minutes or another period of time. The set period of time at which the engine will be stopped from idling may be a period of time sufficient to recharge the battery of the vehicle. Once the battery is recharged the monitoring of the battery level and other settings of the car, such as interior temperature, may be continued, so that steps 26-32 continue to be engaged as necessary until the vehicle is changed from park into drive or at such time as the user of the vehicle indicates that the vehicle is to be turned off indefinitely.

A skilled reader will recognize that the present invention may monitor and maintain other settings in a vehicle in the same manner as is described herein for monitoring and maintaining temperature, for example, such as air circulation or any other settings that affect the environment created by elements of a vehicle, or emergency lighting or other settings that create an environment outside the vehicle.

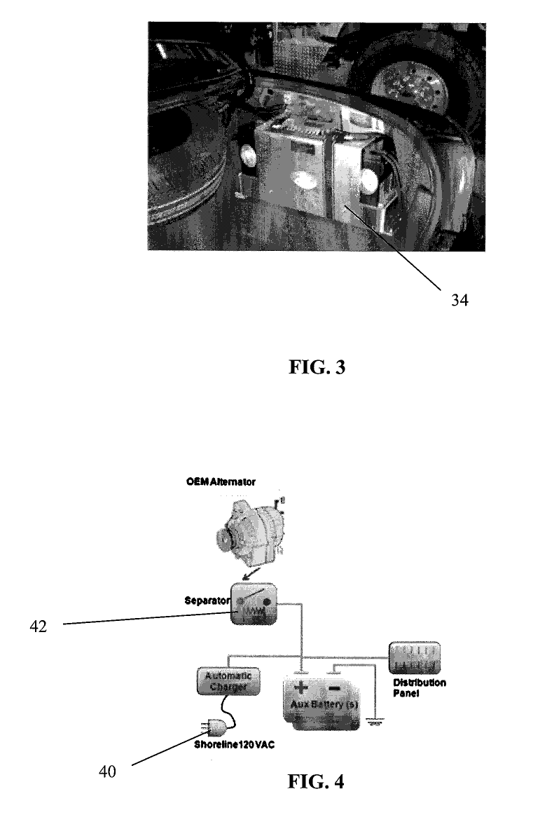

As shown in FIG. 3, an auxiliary energy storage device may be installed in a vehicle, such as in the trunk of a vehicle. A skilled reader will recognize that an auxiliary energy storage device may be installed in other parts of a vehicle. The auxiliary energy storage device may be monitored by a present invention that is utilized with the vehicle, in a manner shown in FIG. 2.

One embodiment of the present invention may involve retrofitting a vehicle to include, or otherwise integrate, one or more off-the-shelf components 40, as shown in FIG. 4. The off-the-shelf components may be installed in the vehicle and integrated with the vehicle. For example, off-the-shelf components may include a stereo system, stylized car lighting, GPS systems, or other components. Such off-the-shelf components may be monitored by the present invention in a manner that is similar to that described in FIG. 2. The present invention may therefore facilitate the use of the off-the-shelf components and other components of the vehicle with the present invention. The present invention may provide for use of the off-the-shelf components, and other components of the vehicle, and to minimize vehicle idling while continuing to meet power requirements for the components.

Another embodiment of the present invention may include one or more large capacity energy storage devices operable to power the various power consuming devices for extended periods of time. For example, the large capacity energy storage devices of the present invention may be utilized to provide auxiliary heating and air conditioning when the engine is off for extended periods of time.

The present invention may be connected to, or otherwise integrated with, a vehicle. The present invention may recognize, or otherwise be linked to, components of the vehicle. For example, the present invention may be linked to power consuming devices of the vehicle, such as emergency lighting, radio, air conditioning unit, heating unit, one or more power outlets operable to supply power to one or more external power consuming devices, etc. An example of an external power consuming device that may be connected to one or more power outlets of a vehicle may be a computer, a cell phone charger, or any other device. The present invention may be operable to monitor settings to be maintained inside or outside a vehicle, as well as levels of power sources of the vehicle or of the present invention, such as a battery of the vehicle or any auxiliary power sources of the present invention.

The present invention may include a control device that includes a programmable device. The control device may be generally operable to monitor and control selected power consuming devices. The control device may function to ensure that there is sufficient electrical power available in a starter power source of a vehicle, such as a battery, to restart the vehicle. The control device may also monitor and maintain particular environmental control targets within or exterior to the vehicle, such as temperature, or emergency lighting, etc.

The programmable device may monitor and control components of the vehicle, to ensure there is always electrical power and the vehicle environment control targets are met. The programmable device may also operate the engine. For example, the programmable device may turn the engine on or off. The programmable device may turn the engine on or off as is required to meet the applicable load requirements of the components of the present invention that require power. The programmable device may also turn the engine on or off as is required to maintain sufficient power to restart the engine. Generally, the engine may be turned off by the programmable device after a specific period of time has elapsed after the vehicle becomes stationary and the transmission is in park or neutral. Generally the engine may be turned on by the programmable device if monitoring of the battery indicates that it is necessary to turn the engine on and to idle the vehicle in order to permit the battery to recharge after it reaches a set level of voltage, such as a voltage that indicates that the battery is nearing being drained.

The present invention may further include a software component. This software component may be linked to the programmable device and may provide instructions to the programmable device. Certain levels or parameters may be stored in the software component. Such levels or parameters may be changeable, or settable, by a user of the present invention, for example, such as an administrative user. Levels or parameters may reflect details specific to the vehicle or any of the power consuming devices or components of the vehicle.

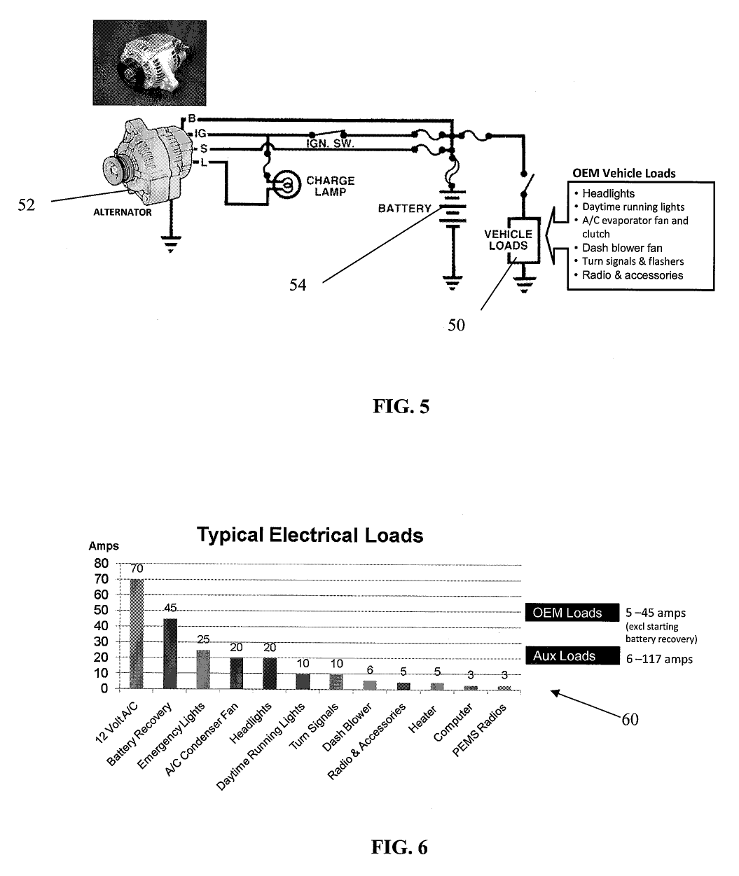

It may be possible for the present invention to be linked to, or otherwise connected to, the electrical circuitry of a vehicle. An example of possible electrical circuitry of a vehicle that the present invention may be utilized with is shown in FIG. 5. An alternator 52 may be connected by circuitry of the vehicle to a battery 54, and to particular vehicle loads 50. The vehicle loads may be OEM vehicle loads and may include loads relating to vehicle components, for example, such as headlights, daytime running lights, air conditioning evaporator fan, clutch, dash blower fan, turn signals, flashing lights, radio, other accessories of the vehicle, etc.

After a vehicle is put into park, and the engine is turned off, the control device of the present invention may be operable to turn an engine on based on the power requirements of the on-board power-consuming devices of the vehicle. The control device may utilize an idle start stop device to turn the vehicle engine on or off. The control device may be included in the programmable device, or may be linked to the programmable device.

The present invention may include, or otherwise be linked to, one or more data devices that enable the real time or near real time collection of data that is relevant to effective monitoring the conditions relevant to management the power requirements. Such data devices be linked to monitoring components or other sensors of the present invention, or may function as monitoring components or sensors. For example, the data devices may include temperature sensors, pressure sensors, flow meters, limit switches, monitors of power consumption, management utilities for alternate power sources etc. The data devices may be utilized by the present invention to provide information that may be analyzed by the present invention. The analysis of the data may be directed to determining how to reduce idling of the vehicle while maintaining adequate power for function of the power consuming devices and adequate power to start the vehicle.

Maintaining adequate power to support the function of the power consuming devices may involve recognizing the devices requiring power (the devices may include both power consuming devices connected to the vehicle, such as a cell phone charger, a laptop, etc., as well as power consuming components of the vehicle, such as heating units, air conditioning units, emergency lighting, radio, GPS, etc.), as well as the power utilized by the devices, which may be achieved through monitoring components or other sensors of the present invention. The monitoring components and/or sensors of the present invention may compare the power required to power the devices to the levels of power available in the battery and any auxiliary power sources of the vehicle or the present invention, to ensure adequate power is available in the battery and any auxiliary power sources to power the devices. Maintaining adequate power to start the vehicle may involve monitoring the voltage level of the starter battery of the vehicle so that the battery is not drained and the level of voltage required to start the vehicle is available in the battery. The present invention may turn the vehicle engine on when insufficient power is detected to be imminent, to thereby recharge the battery and/or any auxiliary power sources.

In one embodiment, the present invention may be operable to change the power source powering one or more devices. For example, if the battery is low on voltage, but one or more auxiliary power sources have available power, the present invention may cause the battery to stop powering the device(s) and one or more auxiliary power sources to start power the device(s). As another example, one or more auxiliary power sources may be utilized to power one or more devices initially, and if the present invention sense that the power is low in one or more of the auxiliary power sources, the battery may be utilized to power the devices instead of the auxiliary power sources on a go-forward basis.

In another embodiment of the present invention, the engine may be turned on by the idle start stop device in order to recharge an auxiliary power source if a sensor detects that the auxiliary power source is drained of, or soon to be drained of, power.

The present invention may be utilized with a variety of vehicles. The present invention may be utilized with such vehicles to generally reduce the idling time required when components of the vehicle, or devices powered by the vehicle, are being operated when the vehicle is in park.

In one embodiment, the present invention may be a system, method and apparatus to be utilized in police and emergency response (EMS) vehicles. Police vehicles are predominantly gasoline powered light-duty vehicles such as sedans, sport-utility vehicles, vans and some light-duty trucks. EMS vehicles are typically any of the following: gasoline and diesel powered Class 1-4 trucks; sports-utility vehicles; commercial vans; or medium duty cut-away chassis' fitted with aftermarket ambulance bodies. A skilled reader will recognize that the present invention can be used in any vehicle where the operator may utilize power consuming devices or power consuming components of a vehicle while the vehicle is stationary and require the vehicle engine at least in part to power the devices or components. The power consuming devices or power consuming components of the vehicle may include devices or components installed as modifications to the vehicle that are aftermarket equipment consisting of power consuming equipment. The aftermarket equipment may be generally powered, at least in part, by the original equipment manufacturer (OEM) vehicle electrical system.

The present invention may be lined to, or otherwise connected with, the vehicle electrical system so that the present invention may operate the alternator and may monitor the voltage of the starter battery. The starter battery may be operable to start the vehicle engine. The starter battery may also provide electrical power to components of the vehicle and to power consuming devices connected to the vehicle by supplying electrical needs for OEM vehicle loads. The alternator, such as an OEM alternator, may be operable to recharge the starter battery, and power vehicle loads.

One embodiment of the present invention may be utilized to decrease the time when a vehicle engine needs to be idled in order to supply power to components of the vehicle and/or power consuming devices connected to the vehicle, including any aftermarket equipment, while the vehicle is stationary. The present invention may be operable to maintain interior temperature levels for extended periods of time when the vehicle is stationary. The present invention may also be operable to ensure that components of the vehicle and/or power consuming devices connected to the vehicle can be powered for a significant period of time while a vehicle is stationary. The components and/or devices may be powered by either utilizing one or more auxiliary power sources, utilizing the battery of the vehicle, or by utilizing a combination of the one or more auxiliary power sources and the battery. For example, the battery may be utilized to power an air conditioning unit, while an auxiliary power source may be utilized to power a laptop plugged into the vehicle. A skilled reader will recognize the variety of combinations to power sources that may be utilized to provide power to components of the vehicle and devices connected to the vehicle.

In one embodiment of the present invention the programmable device of the present invention may monitor overall system performance while the vehicle engine is off to ensure: continued operation of the components of the vehicle or devices connected to the vehicle, including any aftermarket equipment; as well as climate control within an interior of the vehicle. The programmable device may monitor the levels of power available for a network of power storage devices that function as power sources. The programmable device may also monitor other levels and parameters, for example, such as vehicle temperatures, brightness of emergency lighting, etc. Should the monitored devices or parameters reach a determined threshold, the programmable device may undertake one or more specific activities, for example, such as: starting the vehicle engine; recharging one or more of the auxiliary power sources; cycling auxiliary heating, cooling devices on and off as needed; shutting off the vehicle engine; etc. After the vehicle engine has been turned on by the present invention the vehicle engine may be shut off once certain activities are completed or parameters are reached, for example, such as: after a predetermined period of time has lapsed during which time the vehicle has idled; after the energy storage devices are sensed to have been recharged by the vehicle alternator; or after a temperature chosen by a user has been reached in the interior of the vehicle; etc. The programmable device may monitor the overall system performance as well as specific levels and parameters on an ongoing basis.

The programmable device may include, or be linked to, a computer program component, such as a software product. The computer program component may provide instructions to the programmable device, for example, such as definitions of one or more of thresholds for levels and parameters of the present invention.

The programmable device may include: a microcomputer; and one or more control circuits. The one or more control circuits may be operable based on instructions from the microcomputer to send an electronic signal to the vehicle engine. The electronic signal may be sent to the ignition of the vehicle engine. The electronic signal may either cause the vehicle engine to be started or cause the engine to be shut off. The microcomputer may be linked to a computer program component, for example, by linking a memory to the microcomputer, and storing to the memory computer instructions embodying the computer program component.

The programmable device may include a plurality of connections for integrating the device into the vehicle systems. For example, a negative (−) wire connection may be utilized to connect the programmable device to the vehicle electrical system. The programmable device may include a wire connection to link the programmable device to the power terminal of the vehicle, whereby the programmable device may be powered by the vehicle battery. The programmable device may have a separate power source, such as a 12V battery or other power source. The programmable device may not require a connection whereby it may be powered by the vehicle battery, or may be powered by the either of the vehicle battery or the separate battery source as a primary power source, and the other as a secondary power source. An ignition wire may also be provided for linking the programmable device to the vehicle ignition, to enable the starting and shutting off of the ignition. These wire connections with the programmable device may be electrically linked to the vehicle electrical circuit in a variety of manners, including a manner that is known. In one embodiment of the present invention that is wired into a vehicle, the electrical connections may be protected with a fuse.

In one embodiment of the present invention, the programmable device may be a boot loading device. In this embodiment of the present invention the boot loading device may be operated by the computer program component. The software, or firmware, of the programmable device may be modifiable so that it may be operable to implement function changes to the programmable device based on user input.

The programmable device may also include, or be linked to, a tachometer operable to determine vehicle RPM. In one embodiment of the present invention, the programmable device may include a tachometer wire for connection to a tachometer that is part of the vehicle.

The functions of the computer program may be accessible through a fixed connection included in the programmable device. The fixed connection may be of several varieties, for example, such as a USB connection or a wireless connection that may be a Bluetooth connection or other wireless connection. A laptop or display means may be connected to the USB connection in order to display the management functions of the present invention. Alternatively, a display means may be linked to the programmable device.

In one embodiment of the present invention, each of the wire connections that are part of the body of the programmable device may function as “accessory” or “ignition” relays. The programmable device may include a key switch for controlling the operation of the programmable device. In order to make the accessory wire “live” the key may be inserted in the programmable device in the “run” position. In order to deactivate the programmable device, the key may be turned into the “off” position.

The programmable device may be grounded for safe installation.

In one embodiment of the present invention, a setup file of the computer program component may be accessed. For example, the computer program component may be accessed by downloading the file from the programmable device to a laptop. The setup file may be operable to guide an authorized user through the setup or management functions of the present invention. The setup file may be operable to present an icon on the laptop computer that may be utilized to access the setup functions. Utilizing the icon may connect the laptop computer to the programmable device.

The setup file may be operable to calibrate one or more parameters related to the functioning of the programmable device. The setup file causes the programmable device to become programmable, for example, one or more of the following levels, parameters or instructions may be programmed into the programmable device: (1) modification of the read value from the battery, if the voltage indicated by the software is different from that measured at the battery by a user; (2) calibration of the tachometer signal wire to the programmable device, whereby the read value can be modified so that it is consistent with the signal read from the tachometer itself; (3) calibration of the internal and external temperature sensors, whereby the programmable device is linked to one or more temperature sensors, and the programmable device may be operable to initiate the heating or cooling systems of the vehicle based on sensor output, for example, so that if the temperature is below a comfort threshold, for example, such as ten degrees Celsius, then the programmable device, overrides other functions to achieve the temperature targets, even if the engine is required to idle for a longer period of time than is normally target, for example, because the auxiliary storage devices do not have sufficient power; (4) inclusion of the VIN number; (5) providing the “autonome delay”, which determines the maximum time that the system of the present invention is permitted to control the engine during a single period, so that after the time period expires, the system will release control of the vehicle and the engine will shut down, and specifically, once a timer part of the programmable device reaches the time limit, an idle controlling sequence is initiated, thereby triggering the engine to shut down; and (6) ensuring that the OEM battery has sufficient power to restart the vehicle, so that a minimum voltage is defined for the OEM battery, and the programmable device is operable to monitor the voltage, and restart the engine if the voltage decreases to a level that is below the threshold, whereby this threshold may be set higher, by operation of the settings defined by operation of the computer program product of the present invention.

The present invention may be integrated with other components of the vehicle, or to one or more power consuming device connected to the vehicle, to provide a range of features. The following features are described as examples of some possible features of embodiments of the present invention. A skilled reader will recognize that other features are also possible.

An embodiment of the present invention may include a keyless mode that may permit the user of the vehicle to turn off the vehicle engine and manually engage a suitable user interface so as to initiate the programmable device to operate as programmed. This may be useful at emergency scenes when the user of the vehicle knows they will be outside the vehicle for extended periods. The purpose of this mode may be to bypass the idle countdown cycle to minimize engine run time. Typically the programmable device may permit the vehicle to remain in an idle position for a predetermined period of time, provided that the auxiliary storage devices have sufficient power.

An embodiment of the present invention may include a keyless mode that is integrated with a gun rack. This feature of the present invention may operates so that when the keyless mode is engaged by the user of the vehicle the gun rack may be locked. When the gun rack is locked any guns positioned in the gun rack may not be removed.

An embodiment of the present invention may allow for the software to be calibrated for accurate voltage, RPM and temperatures. In this manner a threshold temperature for the interior of a vehicle may be set. The programmable device may monitor the temperature of the interior of the vehicle, and may trigger either the heating system or the air conditioning system to be activated in order to maintain the threshold temperature. Also, the programmable device may identify vehicle engine idling based on engine RPM and or engine temperature. If the RPM is lower than a predetermined threshold, the software may assume that the engine is idling.

An embodiment of the present invention may include software that may accept the either +ve or −ve polarity for input signals.

An embodiment of the present invention may include software that may accept up to eight digital input signals. Any of these digital input signals may negate the present invention's control of the engine. Inputs could include PTO operation, inverter operation, limit switch to indicate position of aerial device boom, pump operation or any high power consumption device operation or any safety limit switches or sensors.

An embodiment of the present invention may include software that may accept two analog input signals sense when the vehicle is in park or neutral. Based on user settings, either of these conditions may trigger the countdown timer operation.

An embodiment of the present invention may include software that may allow ambient temperature to be monitored. If the ambient temperature is below a threshold, the software may use a secondary timer to let the vehicle idle for a longer period of time for passenger comfort.

An embodiment of the present invention may include software that may permit a plurality of configurable outputs, for example, such as four outputs, to control external devices based on specified conditions. The four outputs may be configured by function using a graphical user interface presented by the software. When the function is selected from a drop down menu, sub menus may be provided to for the user to configure thresholds. For example, if the user wants to manage cab temperature with an auxiliary heater, they may select “climate” from the drop down. The software may then allow an authorized user of the management functions of the software to define the temperature ranges for operation of the heater. Another output may be used to define the parameters for operation of the dash fan. For each of the outputs additional thresholds may be established. For example, the heater may be programmed to stay on for 20 minutes after the vehicle is placed in drive and the fan can be programmed to cycle on and off to maintain cab temperature.

An embodiment of the present invention may include levels, parameters, and/or thresholds that may be used as default settings for operation of the programmable device include or associated with components described include: idle time, for example, such as set at 3 minutes; starter battery, for example, such as a battery of 12.3 volts; an auxiliary battery, for example, such as a battery of 11.8 volts; an interior minimum temperature, for example, such as set at 15° C.; an interior maximum temperature, for example, such as set at 27° C.; and an engine run duration, for example, such as set at 10 minutes.

An embodiment of the present invention may include other configurable outputs in the current software may include ignition, external lights, door unlock and alarms.

An embodiment of the present invention may be operable during keyless operation mode, so that when an analog input is set to “stop” and the system is controlling idle, releasing the triggered input may cause the system to shut down engine and release control of idling control.

An embodiment of the present invention may invoke a secondary timer to activate idle control if the temperature is below a threshold temperature, for example, to enable the timer to idle for a longer time for passenger comfort reasons.

An embodiment of the present invention may monitor the voltage of the OEM battery, and automatically restart the engine when the minimum voltage is reached.

An embodiment of the present invention may monitor the voltage of the one or more auxiliary batteries, and depending on the setting defined for the vehicle, the programmable device may be operable to restart the engine if the voltage goes below specific values.

An embodiment of the present invention may be disabled when the vehicle hood is open to prevent automatic engine starts and ensure the safety of maintenance technicians while they service the vehicle.

An embodiment of the present invention may include a modified starting sequence for use with older vehicles. The modified starting sequence may be operated by the computer program product.

An embodiment of the present invention may include a programmable device that starts the vehicle by initiating for example a cranking sequence in relation to the engine starter. A skilled reader will recognize that, depending on the vehicle, it may be necessary to define certain parameters relative to starting the vehicle. The programmable device may access the required parameters to ensure effective startup of the vehicle. For example, the computer program product may access any of the following parameters: a maximum number of allowed engine start attempts; the time between any two engine start attempts; any delay before attempting a start for a diesel vehicle; any parameters for establishing that the engine has started for example minimum RPM pulses, as determined by operation of the tachometer; and/or any specific voltage required to the wire linking the programmable device and the engine starter. The programmable device may be utilizable so that the voltage levels, parameters and/or thresholds may be adjusted based on these requirements.

An embodiment of the present invention may include a programmable device having sufficient memory to store system performance history for periodic downloading via USB to a laptop for analysis and performance tracking.

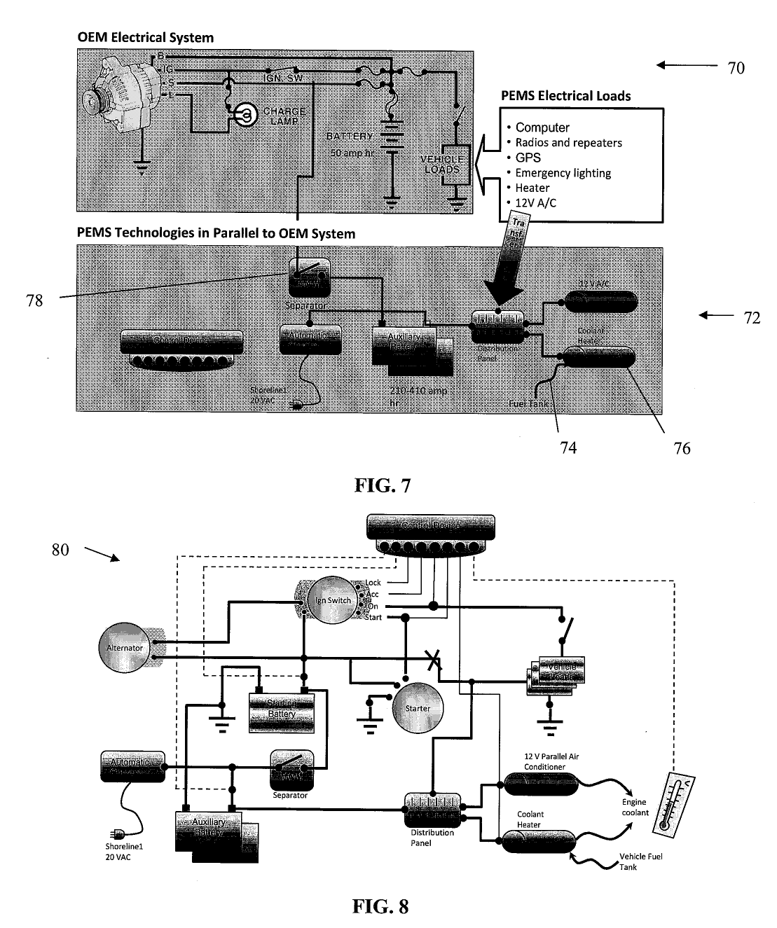

One embodiment of the present invention may include, or be linked to, one or more auxiliary heater units or one or more auxiliary cooling units installed in the vehicle for specific use when the engine is turned off. The auxiliary heating/cooling units may be powered by auxiliary power devices, or by gas sourced from the vehicle fuel tank. For example, as shown in FIG. 7, a coolant/heater 76 that is a gas powered heater, may use vehicle fuel, accessible through a connection 74 to the fuel tank of the vehicle, as an energy source to produce heat and may include a fan for circulation. As another example, if the heater is an air type, warm air may be supplied through from aftermarket vents in the vehicle. As yet another example, if the heater heats engine coolant, OEM vehicle vents may be used to supply to warm air as though the engine is running. The heater may be controlled by a programmable device. The programmable device may cycle the heater and may turn the fans on and off to maintain the temperature within a pre-determined temperature range in the interior of a vehicle. The configuration may be set up to minimize the average electric current draw and maximize the use of residual heat from the engine block.

Another embodiment of the present invention may include one or more auxiliary energy storage devices that may be batteries, solid state devices, or devices that use a small combustion engine to generate electricity. The one or more auxiliary energy storage devices may be set up in parallel to the vehicle electrical system. The energy storage devices for each application may be selected based on expected electrical loads and space availability on the vehicle. High capacity batteries, solid state capacitive devices or auxiliary power units may be used for the system of the present invention. As shown in table 60 of FIG. 6, electrical loads may vary for particular power consuming devices or components of the vehicle. The electrical loads may affect engine run time. The variance in electrical loads and expected electrical loads may be reflected in the configuration of the present invention.

In still another embodiment of the present invention, an energy storage device may be a battery or a solid state. Recharging of the energy storage device may be provided by the vehicle alternator, shore line powered automatic battery charger, or solar panels. Connection to the vehicle alternator may be through a separator device 42, as shown in FIG. 4. The separator may be an aftermarket device designed for the system of the present invention. The separator may be operable to prioritize recharging the vehicle starting battery first. Once the starter battery is fully charged, the separator may direct alternator current to the one or more auxiliary energy storage devices until they are fully charged (if said one or more auxiliary energy storage devices are a battery or are otherwise rechargeable).

In yet another embodiment of the present invention shore line power or solar panels may be used as a supplement to recharging the energy storage devices when a vehicle is stationary. Plugging vehicles into a shore line power or a solar panel may cause energy storage devices to be fully charged and may minimize engine idle time.

In still another embodiment of the present invention an additional air conditioning device, for example, such as an aftermarket 12 volt DC air conditioning (A/C) compressor, may be utilized to provide cooling when the vehicle is stationary and the vehicle is off, but the user still wants the interior of the vehicle to be cooled. The auxiliary A/C compressor may be connected to the OEM coolant lines. When the vehicle engine is running, cooling may be powered by the vehicle engine and when the engine is off power may be supplied by the energy storage device. When the engine is turned off, since the auxiliary A/C shares coolant lines with the vehicle, OEM vehicle vents may be used to supply to cool air as though the engine is running. The auxiliary A/C compressor may be controlled by the programmable device. The programmable device may be operable to cycle the A/C compressor and fans on and off to maintain the temperature in targeted vehicle areas within a pre-determined range. The configuration may be set up to minimize the average electric current draw and maximize the use of residual cooling from the auxiliary A/C compressor.

An embodiment of the present invention 72 may be integrated with an existing OEM system 70 in a vehicle, as shown in FIG. 7. The connection between the OEM electrical circuit and the present invention may be through a connection to the separator 78 of the present invention.

As shown in FIG. 8, an embodiment of the present invention 80 may be configured to be integrated with hybrid technology vehicles.

In an embodiment of the present invention aftermarket equipment may be connected to the programmable device through a distribution panel. The system and energy storage devices may be provided such that power is available to run equipment for extended periods of time with the engine off.

In one embodiment of the present invention, other aftermarket components may be added, for example, such as a charge booster solar panel to assist in keeping the auxiliary energy storage devices at peak charge and reduce sulfate build up.

It is noted that other extensions or modifications of the present invention are possible. The following provides some examples of possible extensions or modifications included in embodiments of the present invention. A skilled reader will recognize that other extensions and modifications may also be possible.

One embodiment of the present invention may include automatic activation of the different control module rules and profiles based on ambient temperature or season. Since power source efficiency varies based on ambient temperature, automatic rule and profile adjustment by the present invention may account for this and optimize the system at any temperature. The rule and profile adjustments may also account for varying heating and cooling power consuming device loads.

Another embodiment of the present invention may include automatic activation of the different control module rules and profiles based on geographic location or to conform with local bylaws or fleet corporate policies. Such activation may be initiated wirelessly from a control centre, by driving past a wi-fi hot spot or by geo-fencing. If geo-fencing is anticipated, the control unit may be equipped with GPS functionality.

Another embodiment of the present invention may include intelligent and dynamic monitoring of power consuming devices to optimize the performance of the overall system. This may include prioritizing power consuming devices in the network and shutting off lower priority devices to delay engine start-up for recharging purposes. Priorities might also be developed based on user safety so as to always have the ability to lower an aerial device under electric power with the vehicle engine off.

Another embodiment of the present invention may include intelligent and dynamic monitoring of energy storage devices to optimize performance of the overall system. The network of devices may include a combination of batteries and solid state devices selected specifically for certain performance characteristics. For example, solid state devices could be prioritized to take advantage of their fast recharge ability.

Another embodiment of the present invention may include data logging of historical or real time system performance metrics such as idle time, energy storage device voltages, power consuming device operation and other metrics. This feature may include driver identification via a blue tooth or RFID to the control device. Data logged could be downloaded for analysis to a laptop via a USB connection or wirelessly using cellular or other wireless technologies.

Still another embodiment of the present invention may provide for energy storage devices to be set up to provide temporary power to the vehicle OEM electrical system for a limp home mode in the circumstance that the vehicle alternator fails.

It will be appreciated by those skilled in the art that other variations of the embodiments described herein may also be practiced without departing from the scope of the invention. Other modifications are therefore possible.

I claim:

1. A system requiring limited idling by a vehicle in a stationary position, said system comprising:
(a) at least one monitoring device linked to one or more power consuming devices of the vehicle and to one or more power sources, said at least one monitoring device being operable to monitor the one or more power consuming devices and the one or more power sources; and
(b) at least one control device linked to the monitoring device, said control device being connected to electrical circuitry of the vehicle, and said control device being operable to start and shut off an engine of the vehicle as required to supply power to the one or more power consuming devices from the one or more power sources, in accordance with the monitoring by the at least one monitoring device.

2. The system of claim 1, wherein the one or more power sources including a starter battery of the vehicle and the control device being operable to maintain sufficient voltage in the starter battery to start the engine of the vehicle.

3. The system of claim 1, wherein the one or more power sources including at least one auxiliary power source operable to power one or more of the one or more power consuming devices.

4. The system of claim 3, wherein the control device being linked to the at least one auxiliary power source and the at least one monitoring device being operable to monitor the at least one auxiliary power source, so that the control device is operable to start the vehicle engine when the at least one auxiliary power source is drained of power to a predetermined threshold to recharge the at least one auxiliary power source.

5. The system of claim 1, wherein the control device being linked to a computer program product operable to provide instructions to the control device to shut off the vehicle engine based on one or more parameters.

6. The system of claim 5, wherein the one or more parameters including a set period of time for idling the engine of the vehicle before shutting the control device shuts the engine off.

7. The system of claim 1, wherein the one or more power consuming devices include one or more of the following: components of the vehicle; or power consuming devices connected to the vehicle.

8. The system of claim 1, wherein the one or more power consuming devices include one or more of the following: a heating unit; an air conditioning unit; emergency lighting; a radio; one or more power outlets operable to supply power to one or more power consuming devices connected to the vehicle; a cell phone charger; a laptop; a GPS; a computer; headlights, including fog lights or daytime running lights; an iPod, MP3 player or other music player; DVD player or other video player; a blower fan; turn signals; flashers; or a lockable gun rack.

9. A method for powering one or more power consuming devices of a vehicle while the vehicle is stationary, the method comprising the steps of:
(a) at least one monitoring device monitoring one or more power sources of the vehicle; and
(b) a control device stopping and starting the engine of the vehicle in accordance with the monitoring of the at least one monitoring device to supply power to the one or more power consuming devices from the one or more power sources.

10. The method of claim 9, comprising the further steps of:
(a) the monitoring device accessing one or more thresholds of the one or more power sources; and
(b) the control device stopping and starting the engine of the vehicle in accordance with the one or more thresholds to supply power to the one or more power consuming devices from the one or more power sources.

11. The method of claim 10, comprising the further step of the control device stopping the engine of the vehicle in accordance with one of the one or more thresholds that is one of the following: the engine is to be stopped three minutes after the vehicle is put into park; and the engine is to be stopped after it has idled for ten minutes after the control device has started the engine.

12. The method of claim 9, comprising the further steps of:
(a) the at least one monitoring device monitoring the temperature of the interior of the vehicle;
(b) the control device comparing the temperature of the interior of the vehicle to a threshold temperature; and
(c) the control device cycling hot or cold air from a heater or an air conditioner that are two of the one or more power consuming devices to maintain the temperature of the interior of the vehicle at the threshold temperature.

13. The method of claim 9, comprising the further steps of:
(a) the at least one monitoring device monitoring the voltage of one of the one or more power sources that is a starter battery of the vehicle;
(b) the control device comparing the voltage of the starter battery to a threshold voltage that indicates that the starter battery is draining; and
(c) the control device starting the engine of the vehicle if the voltage of the battery is at the threshold voltage to recharge the engine of the vehicle.

14. The method of claim 9, comprising the further step of the control device maintaining a starter battery that is one of the one or more power sources at a voltage level sufficient to start the vehicle.

15. The method of claim 9, comprising the further step of the at least one monitoring device monitoring the one or more power sources and the supply of power from the one or more power sources to the one or more power consuming devices on an ongoing basis.

16. The method of claim 9, comprising the further step of one or more auxiliary power sources, that are one or more of the one or more power sources, supplying power to the one or more power consuming devices, said one or more auxiliary power sources being linked to the control device.

17. The method of claim 16, comprising the further steps of:
(a) the at least one monitoring device monitoring the one or more auxiliary power sources to determine the level of power available in the one or more auxiliary power sources;
(b) the control device starting the engine of the vehicle if the one or more auxiliary power sources are drained of power; and
(c) the engine of the vehicle recharging the one or more auxiliary power sources.

18. A computer program product operable for powering one or more power consuming devices while a vehicle is stationary with reduced idling of the vehicle, said computer program product comprising:
(a) one or more instructions processable by one or more computer processors to communicate the one or more instructions to a control device linked to the computer program product, said one or more instructions including one or more thresholds relating to one or more of the following: the one or more power consuming devices; and one or more power sources of the vehicle; and
(b) the control device starting and shutting of the vehicle in accordance with the one or more instructions and the one or more thresholds to cause the one or more power sources to supply power to the one or more power consuming devices.

19. The computer program product of claim 18, wherein the one or more instructions being analyzed by the control device with results from at least one monitoring device monitoring the one or more power sources, so that the control device starts and shuts off the vehicle to minimize the idling of the vehicle while supplying continuous power from the one or more power sources to the one or more power consuming devices of the vehicle.

20. The computer program product of claim 18, wherein the one or more thresholds being displayed upon a display means to a user, said display means being connected to an input means operable so that the user may amend the one or more thresholds and the computer program product will accept the amendments as the one or more thresholds to be utilized on a go-forward basis.
